(19) United States
(12) Patent Application Publication
(10) Pub. No.: US 2023/0276810 A1
(43) Pub. Date: Sep. 7, 2023

(54) COMPOSITIONS AND METHODS FOR SANITIZING AND DISINFECTING ENVIRONMENTS

(71) Applicant: Marcelo Zelicovich, Miami, FL (US)

(72) Inventor: Marcelo Zelicovich, Miami, FL (US)

(21) Appl. No.: 18/010,213

(22) PCT Filed: Jun. 18, 2021
(86) PCT No.: PCT/US2021/038055

§ 371 Date: Dec. 14, 2022

Related U.S. Application Data
(60) Provisional application No. 63/041,356, filed on Jun. 19, 2020.
(60) Provisional application No. 63/086,975, filed on Oct. 2, 2020.

(51) Int. Cl. A01N 65/44; A01N 65/22; A01N 43/16; A01P 1/00

(52) U.S. Cl. CPC A01N 65/44; A01N 65/22; A01N 43/16; A01P 1/00

(57) ABSTRACT

Provided are compositions comprising one more components derived from essential oils and their use for sanitizing or disinfecting environments.

### RELATED APPLICATIONS

This application claims the benefit of priority to U.S. Provisional Application No. 63/041,356, filed Jun. 19, 2020 and U.S. Provisional Application No. 63/086,975, filed Oct. 2, 2020, the entire contents of each of which are incorporated herein by reference.

### BACKGROUND

According to the World Health Organization (WHO), nearly 50,000 people die each day from infectious diseases. At least 30 new diseases have emerged in the last 20 years and now together threaten the health of hundreds of millions of people. The susceptibility to acquire or spread an infectious disease is particularly high in crowded environments, mainly when such environments comprise individuals who are already compromised by an underlying condition (e.g., hospitals, nursing homes, medical treatment facilities, hotels, workplaces, etc.).

Currently, most disinfectant or sanitizing products on the market utilize toxic or corrosive substances, or do not provide economically feasible means for treating large areas for extended periods of time. For example, hydrogen peroxide (H₂O₂) vapors, have been used for sterilization and bio-decontamination. The problem with H₂O₂, however, is that it is highly oxidizing in its vapor form and poses significant health risks when not used properly. Similarly, chlorine-based solutions are highly corrosive and toxic to the lungs. They also leave residues and carry a displeasing pungent odor. Energetic treatments, such as the use of UV light, has recently emerged as an alternative means for “non-chemical” based treatment. However, UV based treatments are expensive to set up and maintain, have limitations for long term use, and bring criticisms on whether such methods foster carcinogenic risks.

### SUMMARY

It has now been found that certain compositions comprising components derived from essential oils can be used to sanitize or disinfect environments.

In one aspect, the disclosed compositions were found to possess fungicidal, bactericidal, and anti-inflammatory activities in the gaseous state. See e.g., the exemplification section below.

In one aspect, the disclosed compositions are non-toxic, easy to apply, and adapted to treat large areas or spaces for extended periods. The disclosed compositions may also be used as a preventive measure, e.g. to maintain a non-therapeutically threatening level of infectious disease-causing agents (e.g., bacteria or fungi) or to reduce the likelihood of acquiring an infectious disease. Additionally, the use of the disclosed compositions may not require professional experience or high costs for treatment.

### DETAILED DESCRIPTION

In one aspect, provided are compositions comprising essential oil components selected from citral, coumarin, 1-(1,2,3,4,5,6,7,8-octahydro-2,3,8,8-tetramethyl-2-naphthalenyl) ethanone, galaxolide, alpha-cedrene, alpha-terpeniol and D-limonene, or a combination thereof.

Citral refers to the chemical (2E) -3,7-dimethylocta-2,6-dienal having the following chemical structure:

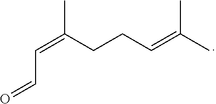

Coumarin refers to chromen-2-one having the structure:

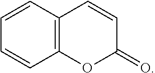 [SMILES: O=c1ccc2ccccc2o1]

1-(2,3,8,8-tetramethyl-1,3,4,5,6,7-hexahydronaphthalen-2-yl) ethanone refers to the compound having the structure:

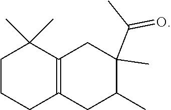 [SMILES: CC(=O)C1(C)CC2=C(CCCC2(C)C)CC1C]

Galaxolide or 1,3,4,6,7,8-hexahydro-4,6,6,7,8,8,-hexamethyl-cyclopenta[g]benzopyran (HHCB) refers to the compound having the structure:

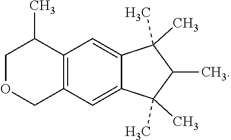

Alpha-cedrene or (1S,2R,5S,7S)-2,6,6,8-tetramethyltriciclo [5.3.1.01,5] undec-8-ene refers to the compound having the structure:

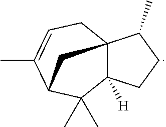

Terpineol or 2-(4-methylcyclohex-3-en-1-yl) propan-2-ol refers to the compound having the structure:

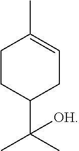

Limonene or 1-methyl-4-prop-1-en-2-ylcyclohexene refers to the compound having the structure:

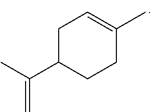

In one aspect, the disclosed compositions can be used to sanitize or disinfect eliminating microorganisms.

In one aspect, provided are compositions comprising essential oil components selected from lemongrass (CAS #8007-02-1), cornmint (CAS #68917-18-0), and Eucalyptus (CAS #8000-48-4). In one aspect, In one aspect, provided are compositions comprising lemongrass (CAS #8007-02-1), cornmint (CAS #68917-18-0), and Eucalyptus (CAS #8000-48-4). In one aspect, the lemongrass (CAS #8007-02-1) is present in an amount ranging from about 40% to about 60%. In one aspect, the cornmint (CAS #68917-18-0) is present in an amount ranging from about 20% to about 40%. In one aspect, the Eucalyptus (CAS #8000-48-4) is present in an amount ranging from about 5% to about 20%. In one aspect, the lemongrass (CAS #8007-02-1) is present in an amount ranging from about 40% to about 60%, the cornmint (CAS #68917-18-0) is present in an amount ranging from about 20% to about 40%, and the Eucalyptus (CAS #8000-48-4) is present in an amount ranging from about 5% to about 20%. In one aspect, the lemongrass (CAS #8007-02-1) is present in an amount of about 50%. In one aspect, the cornmint (CAS #68917-18-0) is present in an amount of about 37%. In one aspect, the Eucalyptus (CAS #8000-48-4) is present in an amount of about 13%. In one aspect, the lemongrass (CAS #8007-02-1) is present in an amount of about 50%, the cornmint (CAS #68917-18-0) is present in an amount of about 37%, and the Eucalyptus (CAS #8000-48-4) is present in an amount of about 13%.

In one aspect, the disclosed compositions are used in vapor form. They can be passed through room aeration systems, e.g., by air conditioning systems and other types of air circulation in different environments to e.g., clean and sanitize the air. These types of air circulation can be hot or cold air. Air conditioning systems can be central air conditioners, wall-mounted air conditioners, split systems, free-standing ones, or any other system that generates forced air circulation regardless of the size of the equipment.

In one aspect, said components in the composition comprise the following percentage ranges (volume/weight): citral approximately 0.05-10%, coumarin approximately 0.05-10%, 1-(1,2,3,4,5,6, 7,8-octahydro-2,3,8,8-tetramethyl-2-naphthalenyl) ethanone about 0.5-60%, galaxolide about 2.5-40%, alpha-cedrene about 0.5-10%, alpha-terpeniol approximately 0.5-10% and D-limonene approximately 0.5-40%, in the composition to be applied to the environment. Alternatively, said components in the composition comprise the following percentage ranges (volume/weight): citral approximately 0.1-5%, coumarin approximately 0.1-5%, 1-(1,2,3,4,5,6,7,8-octahydro-2,3,8,8-tetramethyl-2-naphthalenyl) ethanone about 1-30%, galaxolide about 5-20%, alpha-cedrene about 1-5%, alpha-terpeniol about 1-5% and D-limonene approximately 1-20%, in the composition to be applied to the environment. In another alternative, said components in the composition comprise the following percentage ranges (volume/weight): citral approximately 0.2-2.5%, coumarin approximately 0.2-2.5%, 1-(1,2,3,4,5,6,7,8-octahydro-2,3,8,8-tetramethyl-2-naphthalenyl) ethanone approximately 2-15%, galaxolide approximately 10-15%, alpha-cedrene approximately 2-4%, alpha- terpeniol approximately 2-4% and D-limonene approximately 2-10%, in the composition to be applied to the environment.

An inert material may be added to the disclosed composition. In one aspect, the inert material added to the disclosed compositions is a propellant. The amount of propellant can vary between about 30% and 70% of the volume by weight of the aerosol and depends on the pressure necessary for the aerosol to supply the small vesicles or droplets necessary to achieve the desired effect.

In one aspect, the disclosed compositions (including the previously defined components) plus the propellant can be supplied by any means that effectively delivers, disperses, or vaporizes in the desired environment the composition comprising said components.

Propellants include, for example, compositions comprising difluoromethane, 2,3,3,3-tetrafluoroprop-1-ene, and pentafluoroethane such as Honeywell Solstice® containing 67% difluoromethane, 26% 2,3,3,3-Tetrafluoroprop-1-ene, and 7% pentafluoroethane; 1,1,1,2-tetrafluoroethane such as Dupont's pharmaceutical-grade Dymel® 1234, or any other propellant that does not modify the molecular structure of the fragrance and provides sufficient pressure necessary for the ideal size of the particular finish, or any another propellant known or to be known.

The size of the vesicle/droplet, it is defined by the pressure given by the propellant, and the shape and dimensions of the outlet nozzle, or another equivalent element that replaces it—the smaller the orifice size, the smaller the exiting vesicle/droplet. In one aspect, the vesicle/droplet size is 4 microns or less.

As an alternative, the compositions (including the previously defined components) plus the propellant, can be supplied for example in aerosol delivered through air conditioners using a system similar to that described in patent AR079521B1 (patent application P20100104736) in the name of Marcelo Zelicovich entitled “A room scenting system and a programmable automatic electronic device for the controlled release of liquid products through atomization, vaporization, spraying; linked to a forced ventilation duct or the like “or in patent AR018850B1 (patent application P19990101832) in the name of Marcelo Zelicovich entitled” Device for the controlled release of liquid products in environments by means of atomization, vaporization, spraying and the like”.

Compositions described herein may also be used directly in air by means of other spray or vaporization systems.

In one aspect, the disclosed compositions and uses thereof are highly effective, easy to use, and low cost.

In one aspect, the disclosed compositions are not harmful to the lungs.

In one aspect, the disclosed compositions are easy to apply and can effectively cover large spaces through air conditioning, as well as by direct spraying it by any other means.

The efficiency in the supply of the composition related to the present use can be enhanced by the high coverage through the air conditioners present in airports, hospitals, airplanes, etc., or in any space where the air is treated through a system of return of cooling or heating such as central air conditioners, or any element that generates air flow, and the fact that the result of the aerosol outlet is a gaseous vesicle/droplet, converts the product in a gaseous state into effective enough to eliminate pathogens as verified in the assays of the present application.

The versatility is given that it can be used in any space and environment, such as home, office, cars, or any space that needs to be sanitized.

The dosage is given in the aerosol system and/or another existing system or to be discovered that would allow the composition can be dosed effectively in a gaseous state in the environment. The cost-benefit ratio is based on the simple form of use that allows sanitizing large spaces effectively.

There are many possible applications for the disclosed compositions and uses in various fields. For example, they can be used in sanitizing or disinfecting environments: diffusers, aerosols, use in veterinary environments, candles, incense, room sprays, direct-use disinfectant, air filters. Further uses include, e.g. airplanes, trains, subways, airports, medical offices, offices, schools, public buildings, banks, nurseries, any space to be sanitized, agricultural uses, cleaning of silos, silo-bags (bags where grains are stored), any item that can spread fungi or bacteria, containers, cardboard boxes, plastic containers, duct disinfection, disinfection of factories, gyms, bathrooms, lockers, removal of fungi from wet places, space stations, clothes, sheets, padding, pillows, pets, fungal walls, garbage sanitation, ships, hospitals, etc.

In one aspect, a minimum of approximately 1 μl of the composition plus the propellant is applied for each approximately 900 m³ of air to be covered per hour dispersed in at least one (1) application every 20 minutes. In another aspect, a minimum of approximately 2.5 μl of the composition plus propellant is applied for every approximately 900 m³ of air to be covered per hour dispersed in at least one application every 20 minutes.

The experiments carried out demonstrated the behavior of pathogens exposed to the selected components of essential oils. These examples are presented by way of illustration and in no way limit the scope of the present invention as defined in the claims.

### EXAMPLES

The following eight (8) compositions were prepared as set forth below.

Composition 1

| | Quan- |
|---|---|
| Component | tity |
| D-limonene | 30% |
| 1,3,4,6,7,8-hexahydrocyclopenta[g]isochromene | 20% |
| (galaxolide) | |
| Methyl dihydrojasmonate | 20% |
| Linalool | 23% |
| Benzyl benzoate | 5% |
| Butylated hydroxytoluene | 1% |
| Citral | 1% |

Composition 2

| | Quan- |
|---|---|
| Component | tity |
| Methyl dihydrojasmonate | 20% |
| D-limonene | 10% |
| Linalool | 10% |
| 1,3,4,6,7,8-hexahydrocyclopenta[g]isochromene | 10% |
| (galaxolide) | |
| 1-(1,2,3,4,5,6,7,8-octahydro-2,3,8,8-tetramethyl-2- | 10% |
| naphthyl)ethan-1-one | |
| Linalyl acetate | 10% |
| (6E)-3,7-dimethylnona-1,6-dien-3-ol | 5% |
| Cedrenyl acetate | 5% |
| (E)-beta-Ionone | 5% |
| Lilyal (3-(4-(tert-butyl)phenyl)-2-methylpropanal) | 5% |
| Citral | 5% |
| Allyl cyclohexyl propionate | 5% |

Composition 3

| | quan- |
|---|---|
| Component | tity |
| 1,3,4,6,7,8-hexahydrocyclopenta[g]isochromene | 20% |
| (galaxolide) | |
| Benzyl salicylate | 5% |
| Hexyl cinnamic aldehyde | 5% |
| Cedrenyl acetate | 5% |
| Linalyl acetate | 5% |
| 1-(1,2,3,4,5,6,7,8-octahydro-2,3,8,8-tetramethyl-2- | 5% |
| naphthyl)ethan-1-one | |
| Methyl dihydrojasmonate | 5% |
| Alpha-terpineol | 5% |
| Cumarin | 5% |
| Gamma-methyl ionone | 5% |
| cis-3-Hexenyl salicylate | 5% |
| Lilyal (3-(4-(tert-butyl)phenyl)-2-methylpropanal) | 5% |
| Benzyl acetate | 5% |
| Dimethylbenzylcarbinyl acetate | 5% |
| Butylated hydroxytoluene | 5% |
| Omega-pentadecalactone | 5% |
| Piperonal | 5% |

Composition 4

| | Quan- |
|---|---|
| Component | tity |
| Methyl dihydrojasmonate | 20% |
| Lilyal (3-(4-(tert-butyl)phenyl)-2-methylpropanal) | 20% |
| 1,3,4,6,7,8-hexahydrocyclopenta[g]isochromene | 20% |
| (galaxolide) | |
| Linalyl acetate | 6% |
| 1-(1,2,3,4,5,6,7,8-octahydro-2,3,8,8-tetramethyl-2- | 6% |
| naphthyl)ethan-1-one | |
| D-limonene | 5% |
| 1-(5,6,7,8-tetrahydro-3,5,5,6,8,8-hexamethyl-2- | 5% |
| naphthyl)ethan-1-one | |
| 1-phenylethyl acetate (Gardeniol II) | 5% |
| Linalool | 5% |
| Citral | 5% |
| Genanyl acetate | 1% |
| Citronellal | 1% |
| Piperonal | 1% |

Composition 5

| | Quan- |
|---|---|
| Component | tity |
| 1-(1,2,3,4,5,6,7,8-octahydro-2,3,8,8-tetramethyl-2- | 30% |
| naphthyl)ethan-1-one | |
| 4-tert-butylcyclohexyl acetate | 20% |
| 2-Ethyl-4-(2,2,3-trimethylcyclopent-3-en-yl)-but-2- | 15% |
| en-1-ol (Bacdanol) | |
| 6,7-dihydro-1,1,2,3,3-pentamethyl-4(5H)-indanone | 15% |
| (Cashmeran) | |
| (E)-Beta-Ionone | 10% |
| 1-(2-tert-butyl cyclohexyloxy)-2-butanol | 5% |
| Butyl phenyl methylpropional (lilial) | 5% |

Composition 6

| | Quan- |
|---|---|
| Component | tity |
| 1-(1,2,3,4,5,6,7,8-octahydro-2,3,8,8-tetramethyl-2- | 40% |
| naphthyl)ethan-1-one | |
| 2-Ethyl-4-(2,2,3-trimethylcyclopent-3-en-yl)-but-2- | 25% |
| en-1-ol (Bacdanol) | |
| Methyl dihydrojasmonate | 10% |
| Geraniol | 10% |
| Isoeugenol | 10% |
| 2-Buten-1-one, 1-(2,6,6-trimethyl-3-cyclohexen-1-yl) | 5% |

Composition 7

| | Quan- |
|---|---|
| Component | tity |
| 1,3,4,6,7,8-hexahydro-4,6,6,7,8,8-hexa- | 20% |
| methylindeno[5,6-c]pyran | |
| Ethylene brassylate | 20% |
| Hexyl cinnamic aldehyde | 10% |
| 2-Ethyl-4-(2,2,3-trimethylcyclopent-3-en-yl)- | 10% |
| but-2-en-1-ol (Bacdanol) | |
| D-limonene | 8% |
| Terpinil acetate (isomer mixture) | 5% |
| Linalool | 5% |
| 4-(p-Hydroxylphenyl)-2-butanone | 5% |
| Alpha isomethyl ionone | 7% |
| Methyl ionone (isomer mixture) | 4% |
| Methyl dihydrojasmonate | 2% |
| Cumarin | 2% |
| Citral | 2% |

Composition 8

| | Quan- |
|---|---|
| Component | tity |
| Isopar L | 20% |
| Methyl dihydrojasmonate | 10% |
| Hexyl cinnamic aldehyde | 10% |
| Linalool | 10% |
| Benzyl benzoate | 10% |
| Hexyl salicylate | 5% |
| Ethylene brassylate | 5% |
| 2-iso, butyl-4-methyltetrahydro-2H-pyran-4-ol (Florol) | 5% |
| 3-Methyl-5-phenylpentanal | 5% |
| Cedrenyl acetate | 5% |
| Phenyl ethyl alcohol | 4% |
| Linalyl acetate | 2.5% |
| alpha methylbenzyl acetate (Gardenol) | 2.5% |
| 2-Ethyl-4-(2,2,3-trimethylcyclopent-3-en-yl)-but-2-en-1-ol | 2.5% |
| (Bacdanol) | |
| Cumarin | 2.5% |
| Bourgeonal; p-tert-butyl dihydrocinnamaldehyde (REP2) | 1% |

Biological Activity

The eight (8) compositions detailed above were tested to determine their bioactivity. Three main bioactivities were tested: antibacterial, antifungal, and anti-inflammatory.

In the case of microbes, the ability of the compositions to kill human pathogenic bacteria and fungi was verified. The microorganisms were exposed to the vapors from the compositions, rather than direct contact, to mimic the distribution of the compositions in air. The microorganisms used in this test are abundant and/or problematic in establishments such as hospitals, public places, basements, and wet areas. These microorganisms can cause health problems, such as allergies, infections and inflammations in the lungs and skin, even some of them would be related to the development of cancer. Some of these pathogens are a high priority for treatment in hospitals, as they can become life-threatening episodes. Bacterial strains belonging to different groups (pathogenic Escherichia coli, Acinetobacter baumannii, Pseudomonas aeruginosa, Staphylococcus aureus, etc.), filamentous fungi Aspergillus and Trichophytum, and yeasts Candida albicans and Cryptococcus neoformans were evaluated.

These compositions were also tested for efficacy in removing clinical isolates of multi-drug resistant bacteria, which are very difficult to treat as they are resistant to antibiotics.

The secretion of the anti-inflammatory protein IL-10 secreted by the white blood cells (macrophages) was also evaluated.

The results show that the compositions are active against bacteria and fungi to different degrees. Some are active against only a few strains, while others are active against all strains (Table 1).

Composition 8 was found to induce IL-10 secretion, meaning that a reduction in inflammation has been observed.

TABLE 1
Antimicrobial activity of the compositions expressed as MIC (mg/ml).

| | Bacteria | | | | | | | | | Fungi | | | |
|---|---|---|---|---|---|---|---|---|---|---|---|---|---|
| Comp. | AB | BS | EC | SAL | MRSA | EPI | PA | LIS | SA | AF | CA | CN | TM |
| 7 | R | R | R | R | R | R | R | 1.68 | R | R | R | R | 0.65 |
| 1 | R | R | R | R | R | R | R | 1.68 | R | 1.68 | R | 1.68 | 0.65 |
| 2 | R | R | R | R | R | R | R | 1.68 | R | R | R | 1.68 | 0.65 |
| 8 | R | R | R | R | R | R | R | R | R | R | R | R | 0.65 |
| 5 | R | R | R | R | R | R | R | 1.68 | R | R | R | R | 0.65 |
| 3 | R | R | R | R | R | R | R | 1.68 | R | R | R | R | 0.02 |
| 4 | R | R | R | R | R | R | R | 1.68 | R | R | R | R | 0.01 |
| 6 | R | R | R | R | R | R | R | 1.68 | R | R | R | R | 0.65 |

AB, Acinetobacter baumannii;
BS, Bacillus subtilis;
EC, Escherichia coli;
SAL, Salmonella thyphimurium;
MRSA, Staphylococcus aureus methicillin resistant;
EPI, Staphylococcus epidermidis;
PA, Pseudomonas aeruginosa;
LIS, Listeria monocytogenes;
SA, Staphylococcus aureus;
AF, Aspergillus fumigatus;
CA, Candida albicans;
CN, Cryptococcus neoformans;
TR, Trichophyton mentagrophytes.
R: resistant..

### Application Example

To sanitize or disinfect a 900 m³ environment (300 m² in area by 3 m in height) that has a single central air conditioning system (for example, gym, cinema, theater, commercial premises, a section of a hospital or medical complex), an automatic system with the composition plus the propellant Solstice® is placed in the air conditioning return system. When the system fires every 20 minutes, the space is sanitized for approximately 744 hours. If the system is triggered every 10 minutes (because there is a lot of rotation of people and the doors of the place are opened very often which causes loss of sanitized ambient air), the space is sanitized for approximately 372 hours.

While we have described a number of embodiments, it is apparent that our basic examples may be altered to provide other embodiments that utilize the compounds and methods of this invention. Therefore, it will be appreciated that the scope of this invention is to be defined by the appended claims rather than by the specific embodiments that have been represented by way of example.

The contents of all references (including literature references, issued patents, published patent applications, and co-pending patent applications) cited throughout this application are hereby expressly incorporated herein in their entireties by reference. Unless otherwise defined, all technical and scientific terms used herein are accorded the meaning commonly known to one with ordinary skill in the art.

1. Use of components derived from essential oils for the sanitization or disinfection of environments that require it, wherein the components are selected from the group consisting of citral, coumarin, 1-(1,2,3,4,5,6, 7,8-octahydro-2,3,8,8-tetramethyl-2-naphthalenyl) ethanone, galaxolide, alpha-cedrene, alpha-terpeniol and D-limonene, and their derivatives, and combinations thereof.

2. The use of components derived from essential oils according to claim 1 wherein the component is citral or its derivatives.

3. The use of components derived from essential oils according to claim 1 wherein the citral component or its derivatives is in a percentage of 0.05-10% by weight of the total weight in the composition to be applied to the environment.

4. (canceled)

5. (canceled)

6. The use of components derived from essential oils according to claim 1 wherein the component is coumarin or its derivatives.

7. The use of components derived from essential oils according to claim 1 wherein the coumarin component or its derivatives is in a percentage of approximately 0.05-10% by weight of the total weight in the composition to be applied to the environment.

8. (canceled)

9. (canceled)

10. The use of components derived from essential oils according to claim 1 wherein the component is 1-(1,2,3,4,5,6,7,8-octahydro-2,3,8,8-tetramethyl-2-naphthalenyl) ethanone or its derivatives.

11. The use of components derived from essential oils according to claim 1 wherein the component 1-(1,2,3,4,5,6,7,8-octahydro-2,3,8,8-tetramethyl-2-naphthalenyl) ethanone or its derivatives is in a percentage of approximately 0.5-60% by weight of the total weight in the composition to be applied to the environment.

12. (canceled)

13. (canceled)

14. The use of components derived from essential oils according to claim 1 wherein the component is galaxolide or its derivatives.

15. The use of components derived from essential oils according to claim 1 wherein the component galaxolide or its derivatives is in a percentage of approximately 2.5-40% by weight of the total weight in the composition to be applied to the environment.

16. (canceled)

17. (canceled)

18. The use of components derived from essential oils according to claim 1 wherein the component is alpha-cedrene or its derivatives.

19. The use of components derived from essential oils according to claim 1 wherein the alpha-cedrene component or its derivatives is in a percentage of approximately 0.5-10% by weight of the total weight in the composition to be applied to the environment.

20. (canceled)

21. (canceled)

22. The use of components derived from essential oils according to claim 1 wherein the component is alpha-terpeniol or its derivatives.

23. The use of components derived from essential oils according to claim 1 wherein the alpha-terpeniol component or its derivatives is in a percentage of approximately 0.5-10%, in the composition to be applied to the environment.

24. (canceled)

25. (canceled)

26. The use of components derived from essential oils according to claim 1 wherein the component is D-limonene or its derivatives.

27. The use of components derived from essential oils according to claim 1 wherein the component D-limonene or its derivatives is in a percentage of approximately 0.5-40% by weight of the total weight in the composition to be applied to the environment.

28. (canceled)

29. (canceled)

30. The use of components derived from essential oils according to claim 1 wherein a minimum of approximately 1 μl of the composition plus at least one propellant is applied for each approximately 900 m³ of air to be covered per hour dispersed in the minus one (1) application every 20 minutes.

31-41. (canceled)

42. Use of a composition comprising lemongrass (CAS #8007-02-1), cornmint (CAS #68917-18-0), and Eucalyptus (CAS #8000-48-4) for the sanitization or disinfection of environments.

43. The use of claim 42, wherein the lemongrass (CAS #8007-02-1) is present in an amount ranging from about 40% to about 60%.

44. (canceled)

45. The use of claim 42, wherein the cornmint (CAS #68917-18-0) is present in an amount ranging from about 20% to about 40%.

46. (canceled)

47. The use of claim 42, wherein the Eucalyptus (CAS #8000-48-4) is present in an amount ranging from about 5% to about 20%.

48. (canceled)

49. (canceled)
